(19) United States
(12) Patent Application Publication
(10) Pub. No.: US 2022/0153237 A1
(43) Pub. Date: May 19, 2022

(54) Metered Dispensing System

(71) Applicant: Smart Solutions, Inc., Carlsbad, CA (US)

(72) Inventor: Ryan Wayne Brunskill, Goodyear, AZ (US)

(73) Assignee: Smart Solutions, Inc., Carlsbad, CA (US)

(21) Appl. No.: 17/518,323

(22) Filed: Nov. 3, 2021

Related U.S. Application Data
(63) Continuation-in-part of application No. 16/952,743, filed on Nov. 19, 2020.

(51) Int. Cl. B60S 3/04; G05B 19/05; B01F 15/00; B01F 15/04

(52) U.S. Cl. CPC B60S 3/04; G05B 19/058; B01F 15/00253; B01F 15/00311; B01F 15/00162; B01F 2215/0077; B01F 15/0429; G05B 2219/16; G05B 2219/13144; G05B 2219/1196; B01F 15/042

(57) ABSTRACT

An improved flow rate metering device that provides for the mixing and dispensing of two or more fluids to form final mixture, for example, for automatic washing of cars and trucks. More specifically, the invention is a system that mixes and ejects chemicals, creating a very precise mixture of one or more chemicals with a dilutant, such as water. The device also has the capability of monitoring an entire chemical dilution and release system, comprising multiple chemicals, and using software to document past and current usage rates, along with predicting future usage rates based upon both past usage rates and environmental conditions.

CROSS REFERENCE TO RELATED APPLICATIONS: This application is a Continuation-In-Part of U.S. Utility patent application Ser. No. 16,952,743, with a title of Metered Dispensing System, filed Nov. 19, 2020, which claims priority from U.S. Provisional No. 62/942,813, filed Dec. 3, 2019, the contents of which are incorporated by reference into this application.

STATEMENT REGARDING FEDERALLY SPONSORED RESEARCH OR DEVELOPMENT: This invention was not federally sponsored.

INVENTOR: Ryan Brunskill, citizen of USA and resident of Phoenix, Ariz.

APPLICANT: Smart Solutions, Inc., Delaware.

ATTORNEY DOCKET: Smart-iMeter

### BACKGROUND OF THE INVENTION

Field of the invention: This invention relates generally to the field of pump systems for mixing and metering any viscous fluids. There are several methods in use, all of which have some problem or another. One method which has been used is to mix one or more fluids before being applied to a vehicle that is to be washed. Prior to being applied to the vehicle, each product is diluted using water. Dilution may occur in a solution tank, from which a point-of-use iMeter pulls the product(s)-water combination for application to a vehicle. Alternatively, dilution may also occur as the product(s) and water are being dispensed at substantially the same time by a point-of-use iMeter to a vehicle. In either case, the actual solution applied to each vehicle includes a concentration of one or more fluid and water. A responsibility typically reserved for a vehicle wash operator relates to defining the type and amount of appropriate fluid, and thus, concentrations thereof, that are to be applied by a vehicle wash facility to the various vehicles utilizing the facility.

In particular, the present disclosure relates to an improved flow rate metering device that provides for the mixing and dispensing of two or more fluids to form final mixture, for example, for automatic washing of cars and trucks. More specifically, the invention is a system that mixes and ejects products, creating a very precise mixture of one or more products with a dilutant, such as water. The device also has the capability of monitoring an entire product dilution and release system, comprising multiple fluids, and using software to document past and current usage rates, along with predicting future usage rates based upon both past usage rates and environmental conditions.

One preferred embodiment of the invention is a system that mixes concentrated products with the use of a “tip-less” injector and “non-venturi-based” hardware into a/the precise amount of desired diluted fluids to the tenth (0.10 mL) of a milliliter, with “0” zero waste. This system is built standard with dynamic metering modifications and is able to dispense any liquid types of mixtures for any application. While the technologies behind this invention are expressly not limited to car washes, and indeed are equally applicable to a variety of other fields ranging from beverages such as soda and beer to laundry detergent and any other liquid, the car wash is used as an example because the function—or rather, the current inefficient function—of a car wash is easily understood. Indeed, the technology contained in this patent application can be used for food and beverage industries, for application of cleaning product dispensing, control, and monitoring.

The system gathers the data signals from a customer's car wash and compiles this data on both a cloud and “local” on-site storage. This storage system provides a back-up of data in case there is a malfunction at either the cloud or on-site system. This data is then provided to the customer in a UI format. Because the entire process is computer-controlled, it allows for a completely automated way of accurately mixing a customer's product with water and dispensing it. (I think you need to explain that there is a difference between mixing a product, and diluting that product with water)

Currently, vehicle wash operators will use an assortment of measuring beakers and scales along with product viscosity calculations to determine flow rate and usage. The fluid being applied will be poured into a beaker that sits on a high-end scale. When the product flaw's and is drawn out of the beaker, the amount drawn is noted along with the difference in weight. There is some critical math at this point that must be calculated into the process based on the chemical's viscosity and any other volume influence that affect the draw such as the size of a feed tubing that was dropped into the beaker. If any of the math that has been injected into this process is not accurate, the results are inaccurate. The manufacturers of the products typically provide this math for their fluid and unfortunately, thse figures are not always accurate. This then opens the door for a sizable percentage of error in the final calculations, as any errors can be magnified significantly further down the line of the operation. More or less, the vehicle wash operators have tolerated this issue due to being “close enough” is good enough—particularly as they have nothing better to use.

Most modern car washes, since they have little idea of the exact amount of fluid being used, have very little guidance on when to order new drums of fluid. The general method is to open the drum and put a stick down the opening, to look down the opening and estimate, or by using a sonar measuring device. But, while these methods can give a good estimate of how much of a particular product is left, because the owner has little idea of how much is being used, he/she cannot realistically place orders for new drums of a particular product with much certainty that such an order is timely.

One method car wash owners have used to make sure they have adequate supplies is to buy smaller drums of a particular product and pour it into a larger container. This method raises the chances of contamination, and also requires a car wash owner to have both 55-gallon drums and extra drums of some of the more often-used fluid. This makes the operational footprint even worse than if the owner just replaced an empty 55-gallon drum with a full one.

Therefore, there is a need in the art to move into an electronic space for metering the amount of fluid applied on a vehicle during a washing cycle which eliminates the need for any scales, beakers, or math from the vehicle wash operators. The system would also allow for precise ratios of fluid and dilutants and allow a computer system to constantly monitor the system such that these ratios can be changed if desired. The system would have a small physical and environmental footprint and be safe for workers.

The current invention provides a solution by having a product delivery system that combines a variety of sensors and control valves with various pumps and pressure regulators in a computer-controlled environment such that precise ratios (to the 0.10 of a mL) of a product to a dilutant such as water can be achieved, monitored, and easily changed if the circumstances so require. Product waste is also eliminated with this invention. A preferred embodiment is a car wash system with a small rack of concentrate fluid are mixed in precise ratios as they are sprayed onto the cars. This system allows for the precise measurement of fluid used, which allows for the prediction of when future boxes of the fluid should be purchased, along with an accurate estimate of how much car washes of which type had been administered in the past.

### Objects of the Invention

It is therefore an object of the present invention to provide a system capable of being connected to a public water supply via a hose that provides a self-regulatory system of product deliver.

A general object of the present disclosure is to move into an electronic space for metering the amount of fluid applied on a vehicle during a washing cycle which eliminates the need for any scales, beakers, or math from the vehicle wash operators.

An object of the present disclosure is to provide a method or apparatus whereby fluid could readily be mixed with water in a vehicle wash system which would not waste fluid and/or time, and which would be reliable and accurate in operation.

Another object of the present disclosure is to provide an automated mechanism metering the amount of fluid applied on a vehicle during a washing cycle which removes the inefficient method of physical inspection of usage of one or more fluid and/or products involved in a vehicle washing.

These and other objects and advantages will become more apparent when reference is made to the following description and accompanying drawings.

### Statement of the Invention

This summary is provided to introduce concepts related to an improved flow rate metering device that provides for the mixing and dispensing of two or more fluids to form final mixture, for example, for automatic washing of cars and trucks. The concepts are further described below in the detailed description. This summary is not intended to identify key features or essential features of the claimed subject matter, nor is it intended to be used to limit the scope of the claimed subject matter.

The present disclosure relates to a dispensing and monitoring system for measuring the quantity of multiple fluids of varied viscosities while being supplied to form a final mixture. The system includes a plurality of feed lines for feeding multiple fluids to a fluid intermixing device.

Various objects, features, aspects, and advantages of the inventive subject matter will become more apparent from the following detailed description of preferred embodiments. It is to be understood that the aspects and embodiments of the disclosure described above may be used in any combination with each other. Several of the aspects and embodiments may be combined to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

There has thus been outlined, rather broadly, the more important features of the invention in order that the detailed description thereof may be better understood, and in order that the present contribution to the art may be better appreciated. There are additional features of the invention that will be described hereinafter, and which will form the subject matter of the claims appended hereto. The features listed herein, and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is a flowchart showing the assembly of the various components into the final product, and how this assembly is monitored.

FIG. 2 is a flowchart showing the relationship between the various water and product control valves, air valves and the final spray arches, along with the process of the systems basic operation

One preferred form of the invention will now be described with reference to the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in a computer-readable medium and executed by a computer or processor, whether or not such computer or processor is explicitly shown.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The detailed description of various exemplary embodiments of the disclosure is described herein with reference to the accompanying drawings. It should be noted that the embodiments are described herein in such details as to clearly communicate the disclosure. However, the number of details provided herein is not intended to limit the anticipated variations of embodiments; on the contrary, the intention is to cover all modifications, equivalents, and alternatives falling within the spirit and scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternatives falling within the scope of the disclosure.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the tennis “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may, in fact, be executed concurrently or may sometimes be executed in the reverse order, depending upon the functionality/acts involved.

Unless otherwise defined, all terms (including technical and scientific terms) used herein have the same meaning as commonly understood by one of ordinary skill in the Page 12 of 19 art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

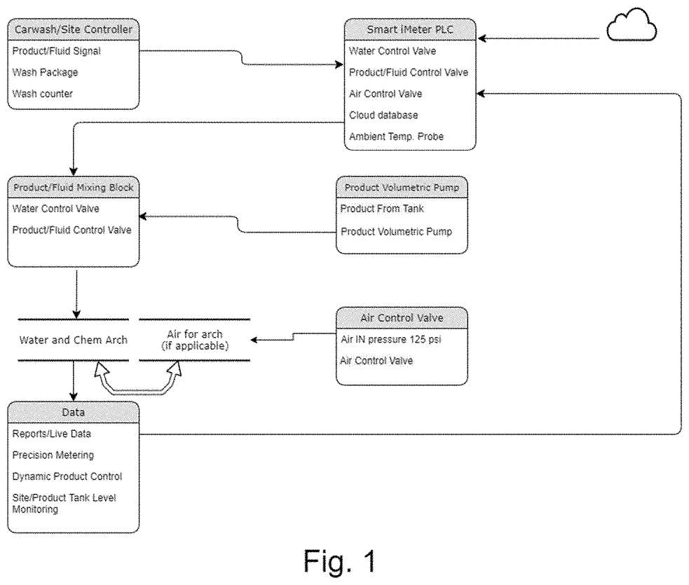

FIG. 1 is a flowchart showing the assembly of the various components into the final product, and how this assembly is monitored. At the carwash, there is an equipment controller that controls the product activation signal(s), the wash package, and the wash counter, which keeps track of how many of what type of car washes have occurred that day. The Smart iMeter couples with the signals from the carwash controller to initiate the product “run” signals to control the water control valve, the product control valve, and the air control valve. The history of adjustments made to these devices are then stored in the cloud.

With respect to controlling the product dispensing, the Smart iMeter causes the water control valve, the product control valve, and the air control valve to affect the production of one or more products for the Water and product Arch and the Air for Arch. The arch is a customer-supplied piece of equipment, usually a metal arch that has a series of nozzles imbedded into it. These nozzles are what sprays the product(s)/mixture(s) onto the car.

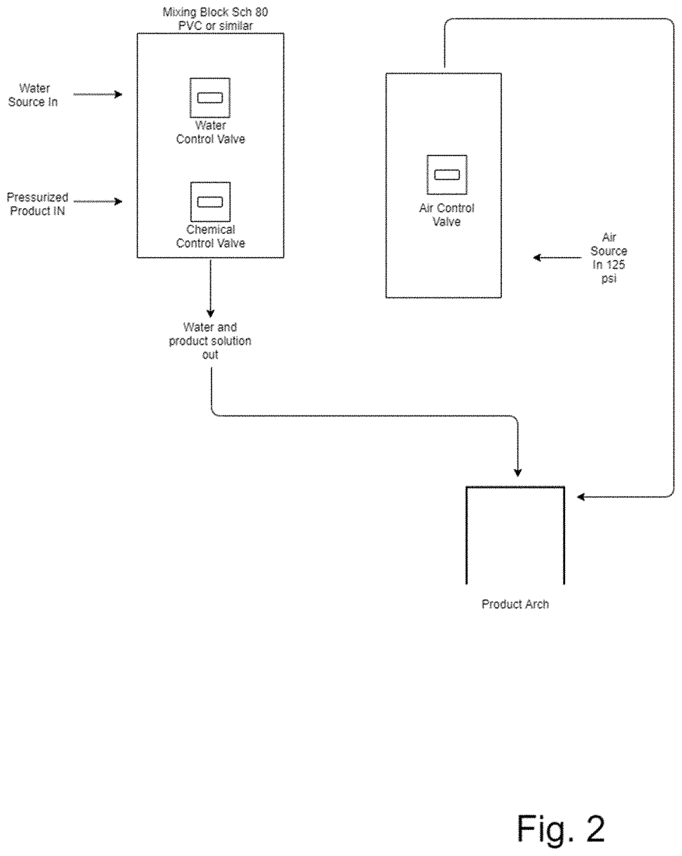

FIG. 2 is a flowchart showing the relationship between the various control valves. The supplied city water connection is stabilized by the bladder pump. Water can be obtained from city water supplies or well water. A pressure transducer reads the water pressure from the bladder pump/city water connection and sends the data to the programmable logic controller (PLC). The software component of the invention recognizes any variances in pressure.

The supplied form of compressed air is used for the volumetric chemical pump and used for “foaming” the product and water components into a foam when it is applied to the car. The control motor controls how much PSI or air flow is needed to make the product more or less foaming. Product pump pressure is produced and mainlined through a proprietary volumetric pump that uses a piston to exert the proper pressure needed for the chemical to enter the mixture manifold via the product control valve.

The product pressure pump is preset and maintained, in a preferred embodiment of the invention, at determined psi. This pressure is then maintained for the duration of the “run” signal. Using a series of check valves, the pump is able to “push out” the chemical, and “pull in” the chemical to refill the volumetric pump without disrupting the general operation. A chemical control valve that has been properly sized for functionality in this invention regulates release of the product(s).

The PLC emits output pulses to control an on/off cycle of the product control valve allowing a drop of product to be introduced into the manifold and mixed with water. The total flow of the product squirted is calculated by how many cycles the valve turned on and off during the product run time from the wash controller.

The air pressure to the control motor is controlled by the PLC and can be adjusted by the user. Air is dispensed directly to the arch manifold. An air pressure transducer installed on the incoming air pressure line notifies the system if a loss in pressure occurs.

The size of the water control valve is determined from the arch properties, such as the number of nozzles, flow rate of each nozzle, size of arch pipes, size of delivery tubing, length of run, etc. The nominal output GPM is 2-15@15-60 psi. Multiple water and product distribution blocks are connected for single product use. Different blocks are setup in the same fashion for other applications.

Ambient temperature inside mechanical room or wash bay (wherever the dispensing unit is located) is monitored and measured. An algorithm determines product viscosity per degree of temperature change and uses the data from a formula table developed in house that encompasses the volumetric pump pressure setting.

The PLC controller receives one or more product demand signals from the carwash controller. A system of events then initiates the water and product control valves, controlling the water control valve the air to mix with the product(s). The software contains a page for parameter setup for the product control valve flow rate. On/off cycles build a usage report for that product used.

It should be noted that the present disclosure is not restricted to be used with a single vehicle-wash bay. Indeed, it is anticipated that the present disclosure will be used in conjunction with multiple vehicle-wash bays, wherein the variation of demand might be even greater and wherein the need for and desirability of the present inventive apparatus and method will be even greater.

The inventive system and device 100 and associated method for metering quantity of fluid supplied through the device 100 are intended to be widely used in the vehicle wash industry. In particular, the present disclosure is particularly applicable to vehicle washes, wherein a great quantity of fluid is used and, thus, it is extremely important to keep the ratio of product to water solvent at an ideal proportion. It should be noted that the method and device proposed herein will work with almost any viscosity of product/product/fluid, and that the method and device can be adapted for use with a great variety of vehicle-washing facilities.

All of the above are only some of the examples of available embodiments of the present disclosure. Those skilled in the art will readily observe that numerous other modifications and alterations may be made without departing from the spirit and scope of the present disclosure. For example, the present disclosure may be used in systems other than vehicle-washing systems, such as conveyor-type vehicle wash systems, drive-through wash systems, or other types of stationary, variable demand spray-wash systems. Accordingly, the disclosure herein is not intended as limiting and the appended claims are to be interpreted as encompassing the entire scope of the invention.

While the foregoing describes various embodiments of the present disclosure, other and further embodiments of the present disclosure may be devised without departing from the basic scope thereof. The scope of the invention is determined by the claims that follow. The present disclosure is not limited to the described embodiments, versions, or examples, which are included to enable a person having ordinary skill in the art to make and use the present disclosure when combined with information and knowledge available to the person having ordinary skill in the art.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What which is claimed:

1. A device for mixing and delivering products, consisting of a programmable logic controller (PLC), a local database, a cloud database, a power source, a smart metering device, and an internet connection, where the smart metering device consist of a water control valve, a chemical control valve and an air control valve, where the programmable logic controller (PLC) sends a signal to the smart metering device, where the signal comprises a plurality of wash figures relating to a chemical signal, a wash package signal, and a wash counter signal, where the smart metering device analyzes the chemical signal, the wash package signal and the wash counter signal, and sends a cloud database signal to the cloud database, and adjust a plurality of valve controls for the water control valve, the chemical control valve and the air control valve, where the programmable logic controller (PLC) monitors a tank level for each of a plurality of tanks and ambient temperature inside a mechanical room or wash bay, where the smart metering device monitors a quantify of water from the water control value, a quantity of chemical from the chemical control valve and a quantity of air from the air control valve into a quantity of car wash liquid, where the quantity of car wash liquid is directed onto a car at a carwash.

2. The device of claim 1, where the Smart metering device comprises the water control valve, the chemical control valve and the air control valve for each single channel.

3. The device of claim 1, where the device relates to the cleaning of a plurality of cars in a carwash, where the device additionally comprises volumetric pump, where the volumetric pump is used for each separate channel to control and regulate a chemical pressure delivered to the chemical control valve.

4. The device of claim 1, where the device additionally comprises an additional air control valve, where the additional air control valve receives an activation signal from the smart metering device when prompted from a site controller to activate and send compressed air to the volumetric pump to apply a set amount of pressure required in each run time during the wash.

5. The device of claim 1, where the device additionally comprises a plurality of monitoring probes, where each of the plurality of monitoring probes measures the tank levels, where the tank levels are transmitted to the cloud database, where the smart metering device receives the tank levels from the cloud database and estimates a number of car washes remaining for a particular chemical for a particular type of the car wash.

6. The device of claim 1, where the programmable logic controller (PLC) determines an amount of the chemical used by calculating the number of times the chemical control valve has opened, and closed, further based on the ambient temperature inside the mechanical room or the wash bay, and an air pressure of the volumetric pump, and a pre-determined formula table.

7. The device of claim 1, where the programmable logic controller (PLC) calculates data from all connected sensors, the chemical signals, the wash package, and the wash counter and puts these into a user-friendly Graphical User Interface (GUI), where a user can monitor, setup, change, and receive alerts remotely through the internet connection.

8. The device of claim 1, further comprising a pressure transducer that reads data of water pressure from a bladder pump/a city water connection and sends the data to the programmable logic controller (PLC) about a constant line pressure and also recognizes any variances in the water pressure.

9. The device of claim 1, where the programmable logic controller (PLC) emits output signals to control on/off wash cycles of the chemical control valve allowing the quantity of chemical to be introduced and mixed with water.

10. The device of claim 1, where the programmable logic controller (PLC) controls the chemical signal, the wash package, and the wash counter to control on/off wash cycles, further calculates a total flow by a number of times a chemical valve is turned on and turned off during the wash cycles, and tracks a number of cars and types of car wash during the wash cycles and/or in a day.

11. A device for mixing and delivering products, comprising a programmable logic controller (PLC), a local database, a cloud database, a power source, a smart metering device, and an internet connection, where the smart metering device comprises of a water control valve, a chemical control valve and an air control valve, where the programmable logic controller (PLC) sends a signal to the smart metering device, where the signal comprises a plurality of wash figures relating to a chemical signal, a wash package signal, and a wash counter signal, where the smart metering device analyzes the chemical signal, the wash package signal and the wash counter signal, and sends a cloud database signal to the cloud database, and adjust a plurality of valve controls for the water control valve, the chemical control valve and the air control valve, where the programmable logic controller (PLC) monitors tank level for each of a plurality of tanks and ambient temperature inside a mechanical room or wash bay, where the smart metering device monitors a quantify of water from the water control value, a quantity of chemical from the chemical control valve and a quantity of air from the air control valve into a quantity of car wash liquid, where the quantity of car wash liquid is directed onto a car at a carwash.

12. The device of claim 11, where the device additionally comprises a plurality of monitoring probes, where each of the plurality of monitoring probes measures the tank levels, where the tank levels are transmitted to the cloud database, where the smart metering device receives the tank levels from the cloud database, and estimates a number of car washes remaining for a particular chemical for a particular type of car wash.

13. The device of claim 11, where the programmable logic controller (PLC) determines the amount of the chemical used by calculating the number of times the chemical control valve has opened, and closed, further based on the ambient temperature inside the mechanical room or the wash bay, and an air pressure of the volumetric pump, and a pre-determined formula table.

14. The device of claim 11, where the programmable logic controller (PLC) calculates data from all connected sensors, the chemical signals, chemical run package selections, and “end of chemical run” signals and puts these into a user-friendly Graphical User Interface (GUI), where a user can monitor, setup, change, and receive alerts remotely through the established Internet connection.

15. The device of claim 11, further comprising a pressure transducer that reads water pressure from a bladder pump/a city water connection and sends the data to the programmable logic controller (PLC) about a constant line pressure and also recognizes any variances in the water pressure.

16. The device of claim 11, where the programmable logic controller (PLC) emits output signals to control on/off wash cycle of the chemical control valve allowing a drop of chemical to be introduced and mixed with water.

17. The device of claim 11, where in the carwash, the programmable logic controller (PLC) controls the chemical signal, the wash package, and the wash counter to control on/off the cycles, further calculates a total flow by a number of times a chemical valve is turned on and turned off during the wash cycles, and tracks a number of cars and types of car wash during the wash cycles and/or in a day.

18. A device for mixing and delivering products, comprising a programmable logic controller (PLC), a local database, a cloud database, a power source, a smart metering device, and an internet connection, where the smart metering device consist of a water control valve, a chemical control valve and an air control valve, where the programmable logic controller (PLC) monitors tank level for each of a plurality of tanks, and ambient temperature inside a mechanical room or wash bay, where the smart metering device monitors a quantify of water from the water control value, a quantity of chemical from the chemical control valve and a quantity of air from the air control valve into a quantity of car wash liquid.

19. The device of claim 18, where the device additionally comprises a plurality of monitoring probes, where each of the plurality of monitoring probes measures the tank levels, where the tank levels are transmitted to the cloud database, where the smart metering device receives the tank levels from the cloud database, and estimates a number of car washes remaining for a particular chemical for a particular type of car wash.

20. The device of claim 18, where the programmable logic controller (PLC) determines an amount of the chemical used by calculating the number of times the chemical control valve has opened, and closed, further based on the ambient temperature inside the mechanical room or the wash bay, and air pressure of the volumetric pump, and a pre-determined formula table.
